(19) United States
(12) Patent Application Publication
(10) Pub. No.: US 2006/0086511 A1
(43) Pub. Date: Apr. 27, 2006

(54) Automatic fire extinguisher

(76) Inventors: J. Fernand Tanguay, Ottawa (CA); Philippe L. LeBlanc, Dieppe (CA)

Correspondence Address: CASSAN MACLEAN, 80 ABERDEEN STREET, SUITE 401, OTTAWA, ON, K1S 5R5, CA

(21) Appl. No.: 10/972,450

(22) Filed: Oct. 26, 2004

(51) Int. Cl. A62C 3/06

(52) U.S. Cl. 169/56

(57) ABSTRACT

A fire extinguishing device for locating over an area subject to a fire risk and configured for automatically releasing a fire retardant material onto a fire occurring there below. A fire resistant housing, having an opening in the bottom thereof, releasably holds a fire retardant material. An operating mechanism operates to release the fire retardant material. A plurality of adjacent doors are configured for collectively closing over the opening during a steady state of the device and for opening upon operation of the operating mechanism to release said fire retardant. Each door is configured for sealing with an adjacent door or the housing during the steady state to form an enclosed compartment of the housing for containing the fire retardant material. A flammable trigger is configured to rapidly ignite and disintegrate when subjected to a flame of the fire and thereby operate the operating mechanism in response to the fire. A release spring of the operating mechanism is held in an extended state by the trigger during the steady state and retracts upon disintegration of the trigger, whereby the doors are caused to open.

### FIELD OF THE INVENTION

This invention relates generally to the field of automatically-activated fire extinguishing devices and, more specifically, to those configured for installation over an area susceptible to fires and particularly suited for home usage.

### BACKGROUND TO THE INVENTION

Many house fires originate on the stove or cook top in the kitchen. Such fires typically commence as relatively small kitchen fires but will rapidly expand, beyond the control of the inhabitants, unless the blaze is extinguished at an early stage of its development. One of the main causes for failing to quickly extinguish a fire, such as a stove fire, is that no-one remains present in the area of the fire at the specific time it commences (for example, this may occur when someone puts something on the stove to cook but then turns their attention to something else, forgetting the item on the stove).

Many different types of fire extinguishers and extinguishing systems are known, including many which are automatically-activated, but many of these incorporate control systems and are triggered by sensors. Generally, because such electromechanical systems are relatively costly and complex they are unlikely to be pursued for household usage or purchases by home consumers.

A simpler, automatic-type fire extinguishing device that is directed for household usage under a stove exhaust hood is described in U.S. Pat. No. 3,884,306 issued 20 May, 1975 to Williams. The embodiments taught by this reference comprise a container having a bottom with a cover that is either removed or ruptured to create an opening through which a fire extinguishing powder therein is released onto a fire, a spring arrangement attached to the cover which operates to either remove or rupture the cover and a fuse which ignites, and a meltable washer member which melts, when a fire occurs and causes the spring arrangement to operate. However, none of these embodiments is easily re-usable as major components of each will either be irreparably damaged or destroyed after they have operated (i.e. the spring arrangement and/or cover). Moreover, the operating arrangements used are not straightforward and may be prone to misfunction, particularly the embodiment using a rotatable shutter.

In view of the foregoing disadvantages of the known fire extinguishers, there is a need for an improved, self-contained, automatic fire extinguisher which can be readily re-used and for which the operating mechanism may be readily inspected according to state regulations and the fire retardant replenished or replaced.

### SUMMARY OF THE INVENTION

In accordance with the invention there is provided an automatic fire extinguishing device (extinguisher) which is configured for an evenly spaced distribution of a fire retardant material over an area subject to a fire risk and can be more readily reused, and its flame retardant material updated, as compared to the known devices. Advantageously, the extinguishing device is triggered by the initial flame of a newly activated fire located below the device so it is self-operated and becomes functional immediately upon the commencement of a fire.

The fire extinguishing device is configured for locating over an area subject to a fire risk and for automatically releasing a fire retardant material onto a fire occurring there below. A fire resistant housing is configured for releasably holding a fire retardant material and comprises an opening in the bottom thereof. An operating mechanism is configured for causing a release of the fire retardant material upon operation of the operating mechanism and comprises a plurality of adjacent doors configured for collectively closing over the opening during a steady state of the device and for opening upon operation of the operating mechanism to release the fire retardant. Each door is configured for sealing with an adjacent door or the housing during the steady state to form an enclosed compartment of the housing for containing the fire retardant material. A flammable trigger is configured to rapidly ignite and disintegrate when subjected to a flame of the fire and thereby operate the operating mechanism in response to the fire.

In the preferred embodiment, the operating mechanism comprises a release spring held in an extended state by the trigger, a door controlling rod coupled to the release spring and to each door, and a master spring coupled to the door controlling rod. Each spring is held in an extended state by the trigger during the steady state, wherein the extended springs retract upon disintegration of the trigger and displace the door controlling rod away from a steady state position thereof, thereby causing the doors to open. Each spring is in its own compartment of the housing and separate from the compartment containing the fire retardant material. At least a portion of the trigger is located below and adjacent the housing, the trigger being coupled to the operating mechanism during the steady state of the device and uncoupling from the operating mechanism upon disintegration of the trigger. The housing preferably, comprises a body and a lid removably secured to the body. The trigger may be comprised of a flammable wooden pin and a flammable sheath may cover the pin. The trigger is coupled to the release spring of the operating mechanism, such as by means of a length of flammable string or thread. Preferably the fire retardant material is non-toxic and it may be a mixture of bicarbonate of soda and course salt. The lid may comprise thereon a magnetic fastener configured for installing the device within an exhaust fan hood.

The fire extinguishing device of the invention may advantageously be incorporated into another apparatus such as a stove top exhaust fan/hood.

Also provided in accordance with the invention is a method for automatically causing a release of a fire retardant material onto a fire when such occurs in an area subject to a fire risk, whereby a fire extinguishing device as described in the foregoing is located over that area.

### DESCRIPTION OF THE DRAWINGS

An exemplary embodiment of the present invention is described below with reference to the following drawings in which like reference numerals refer throughout to like elements.

FIG. 1 is a perspective view of an exemplary embodiment of a fire extinguishing device in accordance with the invention;

FIG. 2 is a pictorial illustration showing an exemplary installation, within a stove exhaust hood, of two fire extinguishing devices as shown by FIG. 1;

FIG. 3(a) is a top view of the exemplary embodiment of FIG. 1 in which the lid of the fire extinguishing device is in position and FIG. 3(b) is a top view of the exemplary embodiment of FIG. 1 in which the lid of the fire extinguishing device is removed to reveal the operable elements thereof;

FIG. 4 is a bottom view of the exemplary embodiment of FIG. 1 in which the lid of the fire extinguishing device is removed and the bottom doors are in their closed position;

FIG. 5 is a left end view of the exemplary embodiment of FIG. 1;

FIG. 6 is a right end view of the exemplary embodiment of FIG. 1;

FIG. 7 is a front view of the exemplary embodiment of FIG. 1, whereby the back view is essentially a mirror image of this);

FIG. 8 is a longitudinal sectional view of the exemplary embodiment of FIG. 1 in which the lid of the fire extinguishing device is removed and the bottom doors are in their closed position;

FIGS. 9(a) and 9(b) illustrate the operation of the exemplary embodiment of FIG. 1. FIG. 9(a) is a longitudinal sectional view of the exemplary embodiment of FIG. 1 in which the lid of the fire extinguishing device is removed and the bottom doors have been activated to move towards their open position, thereby causing a release of the fire extinguishing material. FIG. 9(b) is a longitudinal sectional view of the exemplary embodiment of FIG. 1 in which the lid of the fire extinguishing device is removed and the bottom doors are in their fully open position and all of the fire extinguishing material has been released.

FIG. 10 is a cross-sectional view of the first outer compartment (only) of the exemplary embodiment of FIG. 1.

FIG. 11 is a side view of the trigger of the illustrated exemplary embodiment of the invention.

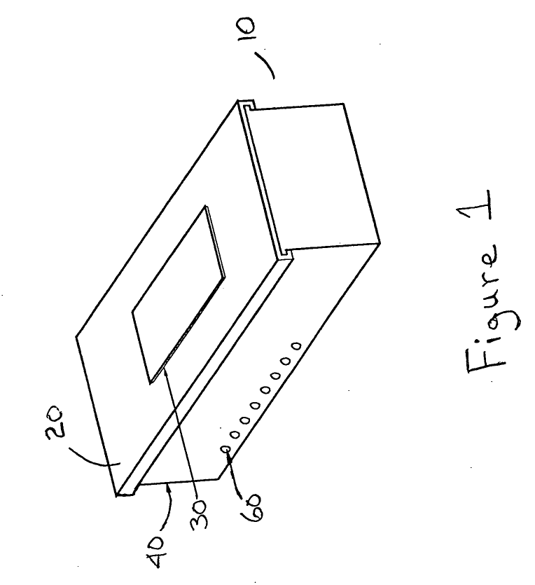

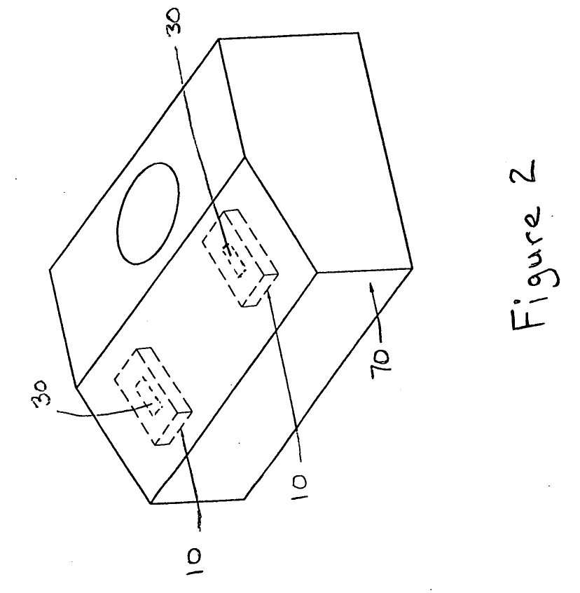

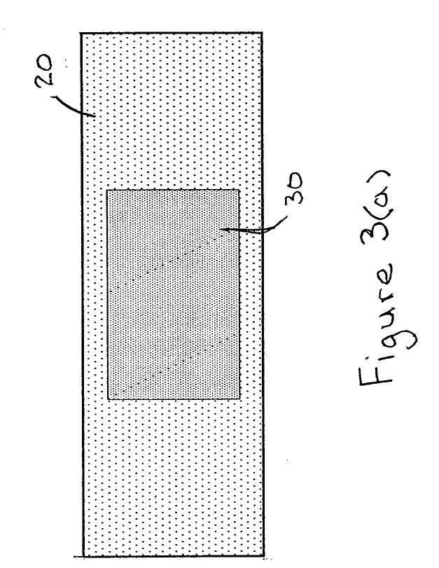

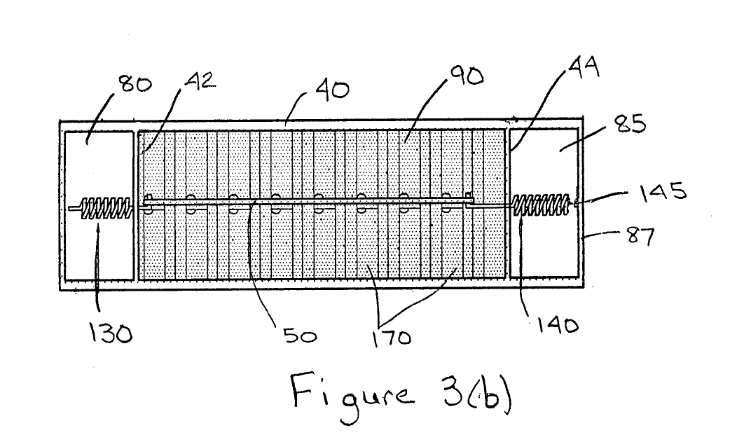

### DESCRIPTION OF THE ILLUSTRATED EXEMPLARY EMBODIMENT

An exemplary embodiment of the fire extinguishing device of the present invention is illustrated by the drawings and described hereinafter.

Referring to FIG. 1 of the drawings there is shown a perspective view of an exemplary fire extinguishing device 10 in accordance with the invention. The device 10 comprises a container formed from a body 40 and a lid 20 there over, each made of steel so as to be fire resistant and durable. Iron is an alternative material which could be used if desired, rather than steel, for another embodiment. FIG. 2 shows an exemplary installation, within a stove exhaust hood 70, of two fire extinguishing devices 10 whereby each device 10 is affixed to an inner surface of the exhaust hood 70 by means of a magnetic fastener 30 affixed to the central outside surface of the device lid 20 (see FIG. 1). Each fire extinguishing device 10 is mounted in the exhaust hood 70 about 2-3 feet above the area subject to a fire risk viz. the stove top. FIG. 3(a) is a top view of the device 10 with its lid 20 in position and FIG. 3(b) is also a top view of the device 10 but with the lid 20 removed to reveal the internal elements of the device. As best shown by FIG. 3(b) and the longitudinal sectional view of FIG. 8, the body 40 is sectionalized by walls 42, 44 into three compartments, namely, first and second outer compartments 80, 85 and a central compartment 90. The operating mechanism of the device 10, in response to a fire, operates according to the principle of a mouse trap which will be known to the skilled reader. Advantageously, this type of mechanism is robust and, when triggered, operates abruptly. As such the selected operating mechanism for the illustrated embodiment is effective to react immediately when triggered by a fire.

The first outer compartment 80 comprises a release spring 130 which attaches at one end, through the wall 42, to a first end of a steel (metallic) door controlling rod 50 which is coupled to the metallic door axles 60 and metallic, rotatable doors 170 and at the other end to a durable (metallic) spring anchor 120. The spring anchor 120 is attached, via a highly flammable fastener 155, to a highly flammable trigger 150.

The second outer compartment 85 comprises a master spring 140 which is under tension when the fire extinguisher 10 is in a ready-to-operate state, that is, when the bottom doors 170 are closed as shown in FIG. 8. Since, in the ready-to-operate state, the master spring 140 is under tension, it will be recognized by the reader that this spring must be suitably to maintain this tensile status on a long term basis without loss of its spring action in order to ensure that it instantly moves towards a retracted (rest) position as soon as the tensile force holding in that extended position is removed. One end of the master spring 140 is fixed to the inside of the second compartment end wall 87 by means of a spring fastener 145, being a hook in this embodiment (the position of which is indicated in the drawings but is not itself depicted). The other end of the master spring 140 is attached to the other end of the door controlling rod 50.

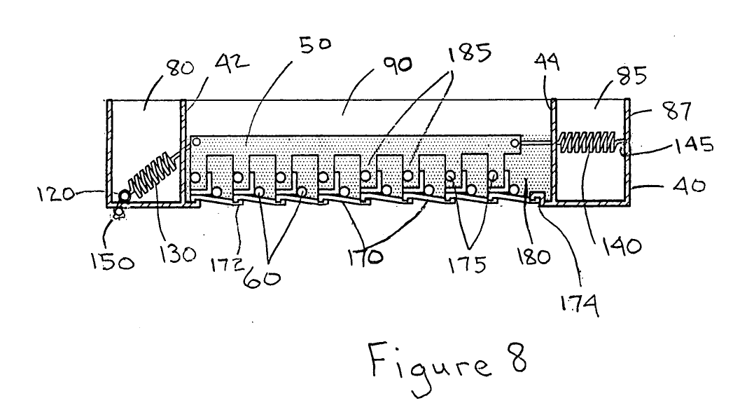

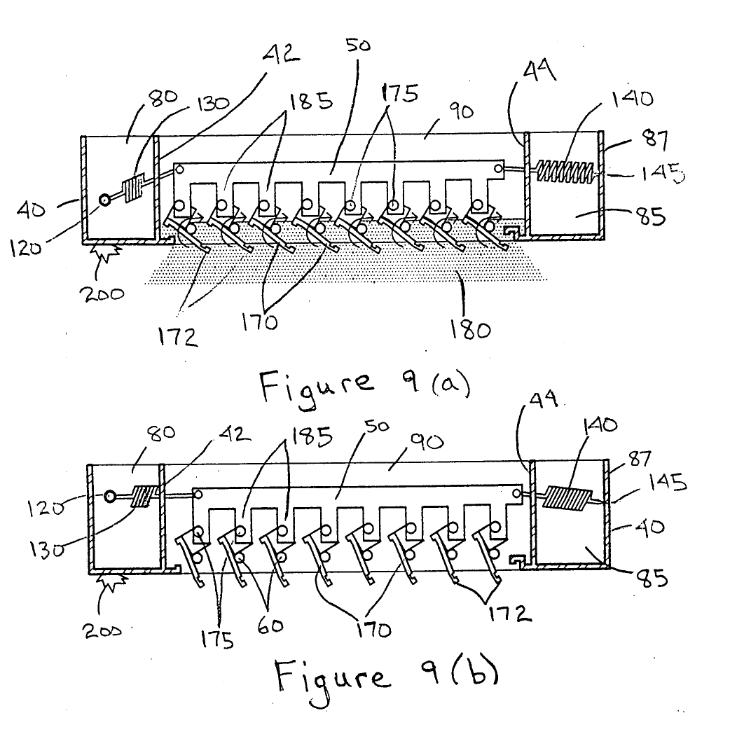

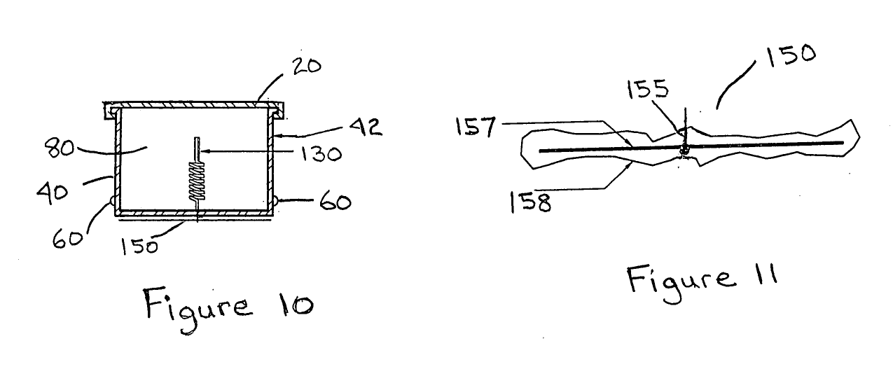

The central compartment 90 comprises a longitudinally extending door controlling rod 50 which is operably coupled to the door axles 60 and the rotatable doors 170 coupled thereto. The rod 50 is linked to the door axles 60 through the extension members 185 attached to it. A fire retardant powder 180 at least partially fills the central compartment 90, the optimal level of fill being dependent on the volume of the central compartment 90, the materials used and related factors which will be readily understood by the skilled reader. In the ready-to-operate state (alternatively referred to herein as the steady state) of the fire extinguishing device 10, the rod 50 is also under tension and has been pulled longitudinally close to the compartment wall 42. In this position of the rod 50 (see FIG. 8), extension members 185 extending from and below the rod 50 are also pulled longitudinally the same distance to rest closer to the compartment wall 42. In doing so, the door axles 60 are caused to rotate and pull up the doors 170 to a closed, steady state, position in which the door ends 172 overlap the adjacent doors and establish seals between each other, or in the case of the outer door end 174 with the body 40, whereby the flame retardant 180 is securely contained in compartment 90. When the release spring 130 is released to cause the master spring 140 to retract and pull the rod 50 towards the compartment wall 44 (see FIGS. 9(a) and 9(b)), the door hinges 175, which couple the extension members 185 and doors 170, also force the rod 50 (with its extension members 185) upwards, higher into the compartment 90. Accordingly, when a fire causes the device 10 to operate the rod 50 is caused to move upwardly and longitudinally towards the second outer compartment 85, the doors 170 are rotated to their open position (see FIG. 9(b)) and the fire retardant 180 is thereby caused to fall from the central compartment 90 onto the fire situated below the device 10. Advantageously, this immediate action in response to a fire will hinder growth of the fire and thereby provide additional time for human intervention or, possibly, in most cases it might even put out the fire itself.

The trigger 150 and fastener 155 coupled to the release spring anchor 120 are both made of a highly flammable material so that they catch fire as soon as they become proximate to a fire 200 and release the spring anchor 120 and release spring 130. As best shown by FIG. 11, the fastener 155 of the illustrated embodiment comprises a short length of a strong linen thread or strong thin string which passes through a small hole in the bottom of the body 40 in the first outer compartment 80 and is attached (e.g. by mean of a knot tied at the end of the thread, as illustrated) at one end immediately below the body 40 to a trigger 150 and at the other end to the anchor 120 of the release spring 130. The trigger 150 is a thin pin 157 comprised of a highly flammable wood such as a balsam wood. Preferably, as shown for the illustrated embodiment, the trigger 150 may also include a highly flammable paper sheath 158 loosely wrapped around the pin 157 to act as an igniter to promote ignition of the pin 157 in the event of a fire. This sheath 158 also serves to protect the pin 157 from an accumulation thereon of steam, grease, oil and dirt.

When the flammable fastener 155 comes into contact with a flame 200, or with a sufficient degree of heat from a proximate flame/fire, it rapidly catches fire and disintegrates, thereby causing a release of the release spring 130. When this occurs the operating mechanism of the device 10 snaps open the doors 170 to immediately release the fire retardant material 180 onto the fire below. This is shown by the sequential moments illustrated by FIGS. 9 (a) and (b). FIG. 9(a) in which the rod 50 is shown to have moved upwardly and longitudinally towards the compartment wall 44 and master spring 140 and the doors 170 are shown to be partially open, with the fire retardant 180 falling down through the openings created by the partially opened doors 170. FIG. 9(b) shows the final resting position of the release spring 130 following its release and the fully opened position of the doors 170, whereby all of the fire retardant 180 has fallen from the device 10 onto the fire.

A powder form of material is used for the fire retardant 180 and the selected powder material for this embodiment is opaque (to prevent oxygen from filtering through it), non-toxic and non-damaging from an environmental perspective, so that it will not present risk to the homeowner or the environment when the device is operated and is relatively simple to clean up. In the illustrated embodiment an amount of 16 ounces of flame retardant powder 180 is placed in the central compartment 90, with the retardant comprising a mixture of bicarbonate of soda and coarse salt (being a blend which prevents caking). This mixture is effective, when released onto a fire, to create a blanket over the fire and deprive it of the oxygen essential to its existence. It is also comprised of non-toxic, edible and environmentally benign ingredients which will not damage the stove or kitchen area it comes into contact with.

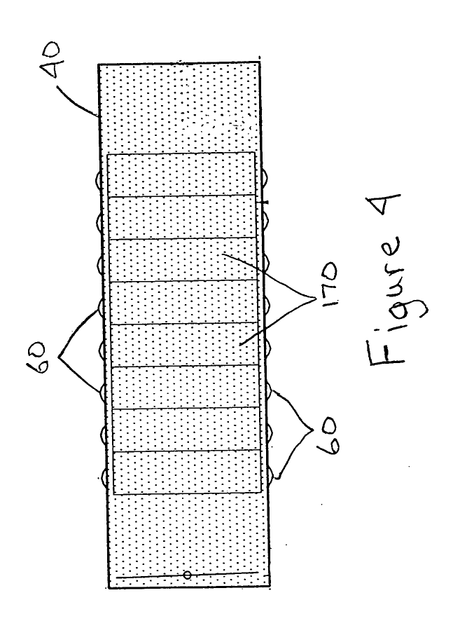

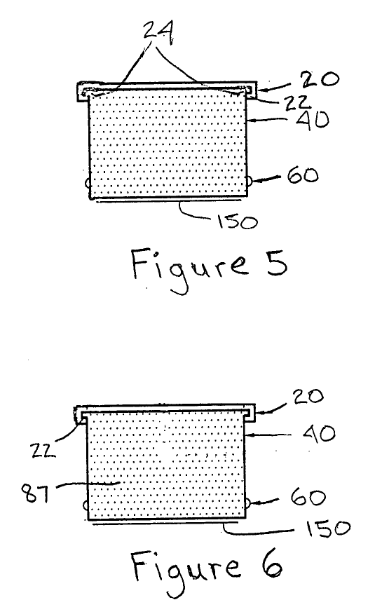

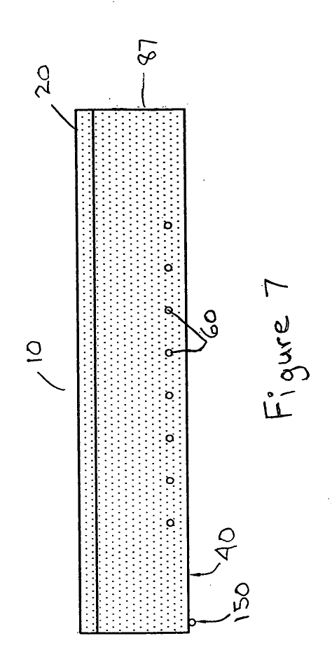

The lid 20 of the fire extinguisher 10 is preferably removable, as shown in the drawings, so as to allow the user to inspect its interior to ensure that the operable elements thereof are in good form and to change the fire retardant material 180 if and when this is desired. As best shown by FIGS. 1, 5 and 6, the lid 20 includes longitudinal grooves 22 which slide fit around lips 22 of the body 40. To remove the lid 20 from the body 40 the lid 20 is moved longitudinally over the lips 22 to slide it off the body 40.

An alternative embodiment may incorporate the fire extinguishing device of the invention directly into the manufacture of a exhaust fan so that it is obtained by the purchaser of each such exhaust fan and needn't be purchased separately or installed by the purchaser. Equally, a further alternative embodiment of the invention may be configured for installation over a different area that is subject to fire risk such as a work space area in which flammable materials are used, or other area subject to such a risk.

Each of the mechanical device components utilised in the foregoing described embodiment of the invention is, individually, well understood by those skilled in the art. It is to be understood by the reader that a variety of other implementations may be devised by skilled persons for substitution. Persons skilled in the field of mechanical design will be readily able to apply the present invention to alternative, effective implementations based upon the description provided herein in respect of the exemplary illustrated embodiment. It is to be understood that the specific types and configurations of the components described herein with reference to the illustrated embodiment are not intended to limit the invention; for example, the invention is not intended to be limited to any specific configuration or type of operating mechanism and the skilled reader will recognize alternative mechanisms that could be adopted for use in place of the mouse trap type of mechanism illustrated herein. Equally, alternative materials for the fire retardant, as well as for the trigger, may be selected for use without departing from the scope of the invention claimed herein.

Consequently, it is to be understood that the particular embodiment shown and described herein by way of illustration is not intended to limit the scope of the invention claimed by the inventors which is defined by the appended claims.

What is claimed is:

1. A fire extinguishing device for locating over an area subject to a fire risk and configured for automatically releasing a fire retardant material onto a fire occurring there below, said device comprising:
(a) a fire resistant housing configured for releasably holding a fire retardant material and comprising an opening in the bottom thereof;
(b) an operating mechanism configured for causing a release of said fire retardant material upon operation of said operating mechanism, said operating mechanism comprising a plurality of adjacent doors configured for collectively closing over said opening during a steady state of said device and for opening upon operation of said operating mechanism to release said fire retardant, each said door being configured for sealing with an adjacent door or said housing during said steady state to form an enclosed compartment of said housing for containing said fire retardant material; and,
(c) a flammable trigger configured to rapidly ignite and disintegrate when subjected to a flame of said fire and thereby operate said operating mechanism in response to said fire.

2. A fire extinguishing device according to claim 1 wherein said operating mechanism comprises a release spring held in an extended state by said trigger, a door controlling rod coupled to said release spring and to each said door, and a master spring coupled to said door controlling rod, each said spring being held in an extended state by said trigger during said steady state, wherein said extended springs retract upon disintegration of said trigger and displace said door controlling rod away from a steady state position thereof, thereby causing said doors to open.

3. A fire extinguishing device according to claim 2 wherein each said spring is in its own compartment of said housing and separate from said compartment containing said fire retardant material.

4. A fire extinguishing device according to claim 3 wherein at least a portion of said trigger is located below and adjacent said housing, said trigger being coupled to said operating mechanism during said steady state of said device and uncoupling from said operating mechanism upon said disintegration of said trigger.

5. A fire extinguishing device according to claim 4 wherein said housing comprises a body and a lid removably secured to said body.

6. A fire extinguishing device according to claim 5 wherein said trigger is a flammable wooden pin coupled to said release spring of said operating mechanism by means of a length of flammable string or thread.

7. A fire extinguishing device according to claim 6 wherein said fire retardant material is non-toxic.

8. A fire extinguishing device according to claim 7 wherein said fire retardant material is a mixture of bicarbonate of soda and coarse salt.

9. A fire extinguishing device according to claim 8 wherein said lid comprises thereon a magnetic fastener configured for installing said device within an exhaust fan hood.

10. A fire extinguishing device according to claim 9 wherein said trigger comprises a flammable sheath covering said pin.

11. A fire extinguishing device according to claim 1 incorporated into another apparatus.

12. A fire extinguishing device according to claim 11 wherein said other apparatus is an exhaust fan with hood.

13. A fire extinguishing device according to claim 2 incorporated into another apparatus.

14. A method for automatically causing a release of a fire retardant material onto a fire when it occurs in an area subject to a fire risk, said method comprising the step of locating over said area a fire extinguishing device according to claim 1.

15. A method for automatically causing a release of a fire retardant material onto a fire when it occurs in an area subject to a fire risk, said method comprising the step of locating over said area a fire extinguishing device according to claim 2.

16. A method for automatically causing a release of a fire retardant material onto a fire when it occurs in an area subject to a fire risk, said method comprising the step of locating over said area a fire extinguishing device according to claim 7.
